(19) United States
(12) Patent Application Publication
(10) Pub. No.: US 2015/0302479 A1
(43) Pub. Date: Oct. 22, 2015

(54) METHOD AND SYSTEM OF DELIVERING LOCALIZED ADDITIONAL DATA

(71) Applicant: YI CHENG, Keelung City (TW)

(72) Inventor: YI CHENG, Keelung City (TW)

(21) Appl. No.: 14/456,358

(22) Filed: Aug. 11, 2014

(30) Foreign Application Priority Data
Apr. 18, 2014 (TW) 103114129

(51) Int. Cl. G06Q 30/02; H04W 4/02

(52) U.S. Cl. CPC G06Q 30/0261; G06Q 30/0267; H04W 4/02

(57) ABSTRACT

A localized additional data delivery method and system for delivering an advertisement data to a portable electronic device located in a related zone are introduced. The system includes a plurality of wireless network base stations for delivering to a nearby zone at least a beacon signal carrying a service setting ID (SSID) accessible to the portable electronic device entering the zone. The portable electronic device gets connected wirelessly to a related one of the wireless network base stations through the beacon signal and receives a webpage data, wherein the SSID is a text code carrying the advertisement data and presented in different languages and is displayed on the portable electronic device. The consumers acquire data directly rather than surf the Internet to search for data in a time-consuming manner. The consumers go physical shopping as easily as online shopping via e-billboards, e-locators, and online promotion data providers.

### CROSS-REFERENCE TO RELATED APPLICATION

This non-provisional application claims priority under 35 U.S.C. §119(a) on Patent Application No(s).103114129 filed in Taiwan, R.O.C. on Apr. 18, 2014, the entire contents of which are hereby incorporated by reference.

### FIELD OF THE INVENTION

The present invention relates to methods and systems of delivering data, and more particularly, to a method and system of delivering localized additional data.

### BACKGROUND OF THE INVENTION

Due to the rapid development of the Internet and portable electronic devices, such as smartphones, tablets, personal digital assistants (PDA), and notebook computers, online shopping is all the rage, but brick-and-mortar stores dwindle.

As a result, people nowadays access a wide variety of information at home and outdoors by portable electronic devices. However, the prior art remains ineffective in associating the information accessed by a user with the user's geographic location. Although the prior art enables the user to access information about shops in the user's vicinity by means of graphical data (such as Google Map), the accessible information is scarce and fragmental. Another drawback of the prior art is that it is difficult to carry out data search and acquisition indoors or in any place where signals are weak or the bandwidth is overly occupied, depending on the strength of the signals transmitted by a communication network (such as a mobile communication network base station operated by a communication service provider.)

Although shopping can be conducted online nowadays, people still have to go outdoors for recreation and leisure. To this end, recreation-goers and leisure-goers (hereinafter referred to as “consumers”) need to be informed of the categories of nearby stores and their retail data instantly and quickly. According to the prior art, consumers have to get connected to the Internet and then search a remote server for related data in a time-consuming and inconvenient manner. As a result, the prior art is not effective in drawing consumers to physical stores.

### SUMMARY OF THE INVENTION

It is an objective of the present invention to provide e-billboards, e-locators, and wireless service and promotion related data to consumers.

Another objective of the present invention is to provide a shopping experience as if the customers were shopping online.

In order to achieve the above and other objectives, the present invention provides a localized additional data delivery method for delivering a related data to a portable electronic device located in a related zone, comprising the steps of: providing a wireless network base station; delivering at least a beacon signal including a service setting ID (SSID) from the wireless network base station such that the portable electronic device in the related zone receives and discerns the at least a beacon signal; and responding by the wireless network base station to an access request from the portable electronic device in the related zone, followed by sending a pre-stored webpage data from the wireless network base station to the portable electronic device, wherein the SSID is configured to be a text code carrying an advertisement data.

In an embodiment of the present invention, the advertisement data is a store name or a store's service data, and the webpage data comprises a retail service description data, a merchandise data, a merchandise price, and/or a map.

In order to achieve the above and other objectives, the present invention further provides a localized additional data delivery system for delivering an advertisement data to a portable electronic device located in a related zone. The localized additional data delivery system comprises: a plurality of wireless network base stations spaced apart from each other and each adapted to send at least a beacon signal carrying an SSID to a nearby zone, so that the portable electronic device which arrive at the zone can not only receive the at least a beacon signal carrying an SSID but also get connected wirelessly to a related one of the wireless network base stations by means of the beacon signal, wherein the SSID is provided in the form of a text code adapted to carry an advertisement data and displayed on the portable electronic device. As soon as the portable electronic device gets connected to a related one of the wireless network base stations, the wireless network base station delivers a pre-stored webpage data to the portable electronic device. The webpage data comprises a retail service description data, a merchandise data, a merchandise price, and/or a map.

In an embodiment of the present invention, the wireless network base stations each comprise: a controlling and processing module which not only configures and stores the text code and the webpage data, but also generates the at least a beacon signal in accordance with the text code; and an antenna connected to the controlling and processing module and adapted to send the at least a beacon signal regularly which enables the wireless connection of the portable electronic device. Furthermore, the wireless network base stations each comprise a wired connecting portion connected to the controlling and processing module. The wired connecting portion comprises a network port and/or a USB port. The data storage module gets connected to the wireless network base station by means of the wired connecting portion.

In an embodiment of the present invention, the wireless network base stations are each a Wi-Fi base station. The beacon signals are transmitted by each of the wireless network base stations at a frequency which complies with IEEE 802.11 Protocol.

In order to achieve the above and other objectives, the present invention further provides a localized additional data delivery system located in a retail zone that harbors a plurality of stores. The localized additional data delivery system comprises a plurality of wireless network base stations located at stores, respectively. The wireless network base station of each store delivers to the retail zone at least a beacon signal including an SSID accessible to portable electronic devices in the retail zone to search for related data and display the data as each of the portable electronic devices get connected wirelessly to a related one of the wireless network base stations by means of the beacon signals, wherein the SSID is provided in the form of a text code which carries the retail data of the related store and is displayed on the portable electronic devices.

Hence, the present invention allows the consumers to dispense with the hassles of surfing the Internet to search for data in a time-consuming manner by enabling the consumers to acquire data directly. Hence, according to the present invention, for example, the consumers are informed instantly of merchandise categories, merchandise prices, and vacancies of nearby restaurants, make a restaurant reservation directly, and receive availability notice with their portable electronic devices. Accordingly, with the present invention, not only do the consumers save time, but the physical stores also generate increased revenues.

Hence, the present invention is useful in providing e-billboards, e-locators, and wireless service and promotion related data whereby the consumers go physical shopping as easily as online shopping. Furthermore, the present invention involves integrating a wireless network base station and a Website (by integrating the webpage data stored in the controlling and processing module and the data provided by the data storage module) so as to integrate Website data service, location, and Wi-Fi connection, provide a novel innovative service system, enables physicals stores to sell goods and provide services smartly and conveniently, and enables consumers to spend smartly and conveniently.

### BRIEF DESCRIPTION OF THE DRAWINGS

Objectives, features, and advantages of the present invention are hereunder illustrated with specific embodiments in conjunction with the accompanying drawings, in which:

FIG. 1 is a flow chart of an additional data delivery method according to an embodiment of the present invention;

FIG. 2 is a schematic view of an additional data delivery system according to an embodiment of the present invention;

FIG. 3 is a function block diagram of the additional data delivery system according to an embodiment of the present invention; and

FIG. 4 is a schematic view of the additional data delivery system for use in a retail zone according to an embodiment of the present invention.

### DETAILED DESCRIPTION OF THE PREFERRED EMBODIMENTS

The present invention is characterized in that: consumers search a service setting ID (SSID) checklist, which is provided by a Wi-Fi base station and displayed on portable electronic devices in the possession of the consumers, for store names and service data presented in different languages, get connected to the Wi-Fi base station, and access data, such as location-related data (for example, maps) and service-related data, pertaining to the stores. As its name indicates, the Wi-Fi base station ensures that all the service providers and stores located by the consumers through the Wi-Fi base station must be in the vicinity of the consumers, and ensures all the accessible data are relevant. Also, the SSID checklist of the Wi-Fi base station gets updated automatically and instantly while the consumers are moving around. Hence, the consumers can access data pertaining to nearby stores in an automated and conveniently manner. When compared to the prior art, the present invention provides a data delivery method which enables physicals stores to sell goods and provide services smartly and conveniently and enables consumers to spend smartly and conveniently. The Wi-Fi base station includes conventional Wi-Fi hotspots, Wi-Fi access points (AP), and wireless AP, which provide wireless access.

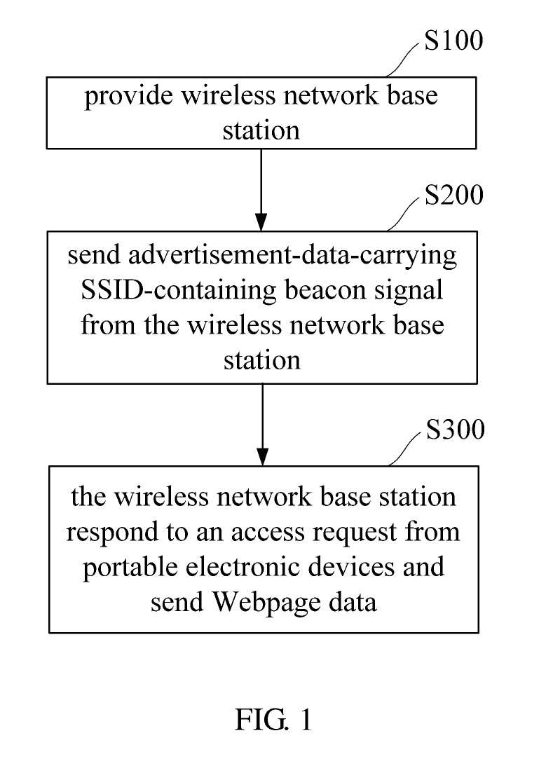

Referring to FIG. 1, there is shown a flow chart of a localized additional data delivery method according to an embodiment of the present invention. As shown in the diagram, the localized additional data delivery method of the present invention sends a localized additional data to the portable electronic devices located in a related zone. The localized additional data delivery method comprises the steps as follows:

Step S100: providing a wireless network base station;

Step S200: sending at least a beacon signal including a service setting ID (SSID) from the wireless network base station such that the portable electronic devices in a related zone can receive and discern the at least a beacon signal, wherein the SSID is configured to be a text code which carries an advertisement data, and the text code can be presented in different languages; and

Step S300: responding, by the wireless network base station, to an access request from the portable electronic devices in the related zone, followed by sending pre-stored webpage data from the wireless network base station to the portable electronic devices.

According to the present invention, the advertisement data includes store name, store's service data, or any other data that attracts consumers. The webpage data includes retail service description data, merchandise data, a merchandise price, a map, or a combination thereof. A point to note is that the wireless network base stations of the present invention are not necessarily capable of getting connected to the Internet; instead, it is also practicable that the wireless network base stations of the present invention can distribute advertisement data by sending the beacon signals.

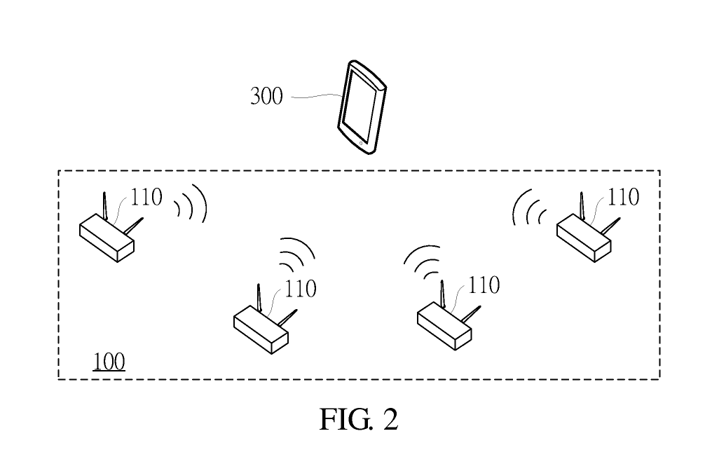

Referring to FIG. 2, there is shown a schematic view of an additional data delivery system according to an embodiment of the present invention. According to the present invention, a localized additional data delivery system 100 comprises a plurality of wireless network base stations 110 spaced apart from each other and each adapted to send at least a beacon signal carrying an SSID to a nearby zone. The wireless network base stations 110 each comprise a Wi-Fi base station and send the beacon signals by IEEE 802.11 Protocol or at any frequency suitable for data transmission, for example, 2.4 GHz, 5 GHz, and the like under IEEE 802.11 Protocol.

According to the present invention, the beacon signals from the wireless network base stations 110 are received by a wireless network module (such as Wi-Fi module) of a portable electronic device 300 in the vicinity of the wireless network base stations 110, such that a user can use the wireless network module to search for a nearby base station and see the SSID carried by the beacon signals, wherein the SSID is provided in the form of a text code adapted to carry an advertisement data and presented in different languages.

Accordingly, as soon as the portable electronic device 300, such as smartphones, tablets, personal digital assistants (PDA), notebook computers, or any other portable electronic devices for use in wireless connection, enters the broadcast service accessible area of the wireless network base stations 110, the portable electronic device 300 can receive the beacon signals regularly sent from the nearby wireless network base stations 110. The portable electronic device 300 gets connected in a wireless manner to a related one of the wireless network base stations by means of the beacon signal. Due to the limit of the range of the transmission of the beacon signals transmitted by the wireless network base stations 110, if the portable electronic device 300 in the possession of a user receives a beacon signal from a specific store, it will indicate that the store must be in the vicinity of the user, such that the user will instantly access data pertaining to nearby stores.

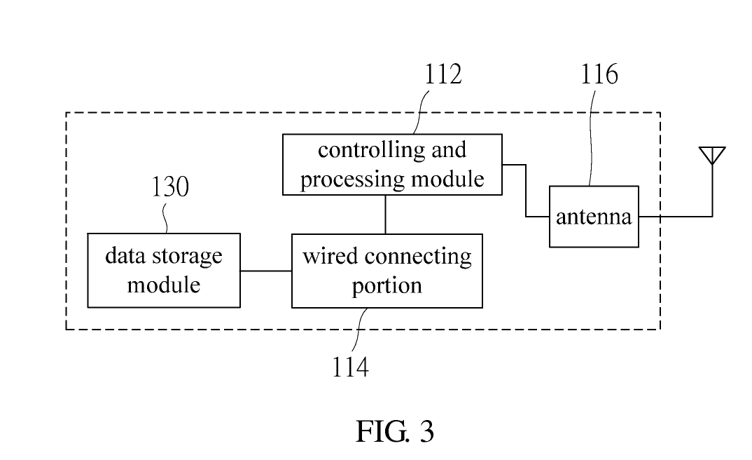

Referring to FIG. 3, there is shown a function block diagram of the additional data delivery system according to an embodiment of the present invention. The wireless network base stations 110 of the present invention each comprise: a controlling and processing module 112, a wired connecting portion 114, and an antenna 116. The wired connecting portion 114, which is optional, is connected to a host computer or an external hard disk drive through the wired connecting portion 114, such that a data storage module 130 can provide extra data storage space, and the data stored in the data storage module 130 further supplements the webpage data initially stored in the controlling and processing module 112. As shown in FIG. 3, the additional data delivery system according to an embodiment of the present invention is exemplified by the wired connecting portion 114 and the antenna 116.

The controlling and processing module 112 not only configures and stores the text code, but also generates the at least a beacon signal in accordance with the text code. The controlling and processing module 112 functions as the kernel of the operation of the wireless network base stations 110, as it stores the editable advertisement data (such as store names and promotion-related data) carried by the SSID. The wireless network base stations 110 store the beacon signals and adjust the frequency at which the beacon signals are emitted. The antenna 116 is connected to the controlling and processing module 112 and controlled by the controlling and processing module 112 to send the at least a beacon signal regularly. The antenna 116 is wirelessly connected to the portable electronic device 300 and adapted to send a pre-stored webpage data to the portable electronic device 300. The wired connecting portion 114 is connected to the controlling and processing module 112. The wired connecting portion 114 is exemplified by a network port (such as RJ-45) or USB port, wherein the wired connecting portion 114 can also include both the RJ-45 and USB port. Hence, the controlling and processing module 112 stores therein the webpage data which can be sent to the portable electronic device as soon as the portable electronic device gets connected to a related one of the wireless network base stations. The webpage data comprises a retail service description data, a merchandise data, a merchandise price, and/or a map, which are/is presented to create a preliminary advertisement layout (which contains information regarding the location, features, and services of a store) as soon as the portable electronic device gets connected to a related one of the wireless network base stations. The data storage module 130 functions as a source of supplementary data and thus provides further data and service-related data (such as a membership database.)

Referring to FIG. 3, the data storage module 130 is connected to the controlling and processing module 112 of a corresponding one of the wireless network base stations 110. As mentioned before, the data storage module 130 comprises a storage space which further provides supplementary data. The controlling and processing module 112 instructs the portable electronic device 300 to read data stored in the data storage module 130, as soon as the portable electronic device 300 gets connected wirelessly to a related one of the wireless network base stations 110. For example, the data storage module 130 stores data, including data pertaining to picture files and message boards, or stores membership data accessible to the controlling and processing module 112 of the wireless network base stations 110 for login authentication. Alternatively, the data storage module 130 is connected, whether in a wired or wireless manner, to a host computer of the wireless network base stations 110 in order to provide the aforesaid data and membership data. Hence, after selecting an intended SSID on the portable electronic device 300, a user gets connected to a related one of the wireless network base stations 110 by means of the beacon signals, such that the portable electronic device 300 displays the webpage data which is accessible to and operable by consumers in order for the consumers to acquire additional data. The data storage module 130 is provided in the form of a host computer. The host computer is connected to the controlling and processing module 112 of a corresponding one of the wireless network base stations 110 through the antenna 116 or the wired connecting portion 114 (as shown in FIG. 3 which illustrates wired connection). That is to say, the host computer functions as a server in a local area network (LAN), but the present invention is not limited thereto.

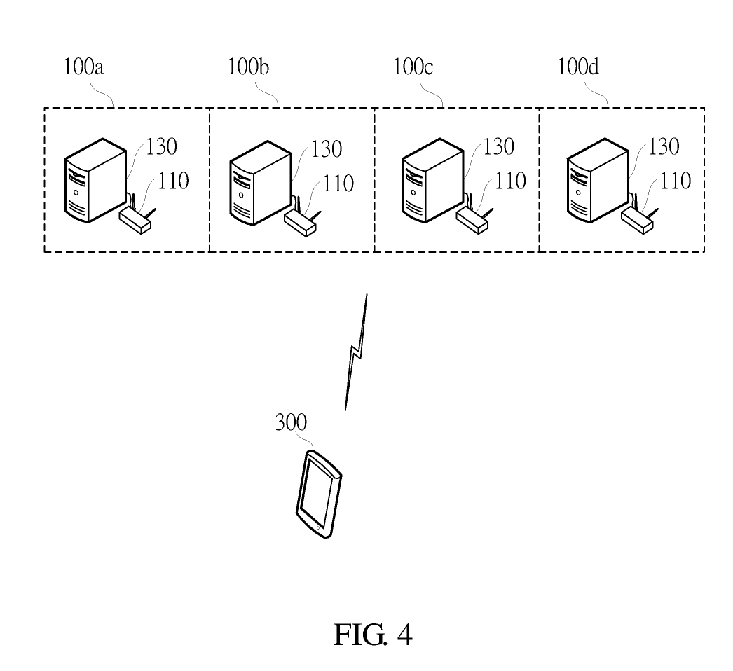

Referring to FIG. 4, there is shown a schematic view of the additional data delivery system for use in a retail zone according to an embodiment of the present invention and exemplified by a food court in a department store. Once consumers arrive at the food court, i.e., the retail zone, each of the consumers will receive beacon signals from the wireless network base stations (110a-110d) dedicated to all the stores in the food court through the portable electronic device 300 in the possession of the consumer. The SSID of the beacon signals match the retail data (such as store name, promotion-related data, today's special offers, and menus) of the stores. When attracted to the retail data, the consumers select the retail data and get connected to the Website of the stores responsible for the retail data, so as to access the webpage data in order to acquire all the retail data of the stores. Hence, the consumers dispense with the hassles of visiting all the stores one by one before picking the favorite store.

Seats at food courts in shopping malls are often occupied at dining hours. In view of this, the present invention enables a consumer to get a seat promptly and then browse the retail data pertaining to each store with the portable electronic device 300 at his or her leisure while sitting at the food court, thereby enhancing consumer experience. On the other hand, the stores, whether conspicuously located or inconspicuously located (for example, when hidden by a pillar or located at a corner in the retail zone), have equal opportunity to build a clientele. Furthermore, the present invention provide e-billboards, e-locators, and online promotion data providers whereby the consumers go physical shopping as easily as online shopping.

Accordingly, a comparison of the present invention and the prior art is as follows:

| Prior Art | Present Invention |
|---|---|
| SSID is for differentiating supplier names and | SSID is indicative of store logos and services. |
| consumer names. | |
| Wi-Fi base station provides connection to the | Wi-Fi base station provides store-related data |
| Internet. | and service-related data. |
| The data fetched online by a consumer with | The data fetched online by a consumer with |
| Wi-Fi base station does not depend on the | Wi-Fi base station is indicative of a store in the |
| consumer's location. | vicinity of the consumer. |
| Regardless of a consumer's location, store | Store data fetched by a consumer varies with |
| data found by a keyword entered by the | the consumer's location. |
| consumer and fetched by the consumer is | |
| invariable. | |
| Wi-Fi-enabled SSID checklist shows different | Wi-Fi-enabled SSID checklist is a checklist of |
| access points only. | store logos and services. |
| SSID are presented mostly in English. | SSID are presented in different languages to |
| | indicate logos and business particulars. |
| Data accessed by consumers have to be parsed | Consumers access data as needed. |
| by the consumers before use (because data | |
| fetched from the Internet is always copious.) | |

In conclusion, the system and method of the present invention allow the SSID to be edited and allows the delivered text code to be presented in local languages (such as English, Chinese, or Japanese), such that consumers can read e-logos and digitalized business particulars on a Wi-Fi-enabled checklist with portable electronic devices, and the e-logos and business particulars displayed on the portable electronic devices are presented in local languages. The system and method of the present invention further allow the consumers to select “connection” conveniently. For example, stores can perform SSID broadcast with e-logos and digitalized business particulars, using keywords, namely McDonald's (Xinyi Branch), real estate agent (Sinyi Realty Inc.), and Starbucks (Nanjing Branch), for example. The system and method of the present invention integrate a wireless network base station and a consumer's location; hence, the consumer can access various Wi-Fi checklist data with his or her portable electronic device and thereby acquiring handy service data while doing physical shopping. Last but not least, the system and method of the present invention provide e-billboards, e-locators, and online promotion data providers whereby the consumers go physical shopping as easily as online shopping.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A localized additional data delivery method for delivering a related data to a portable electronic device located in a related zone, comprising the steps of:
providing a wireless network base station;
delivering at least a beacon signal including a service setting ID (SSID) from the wireless network base station such that the portable electronic device in the related zone receives and discerns the at least a beacon signal; and
responding by the wireless network base station to an access request from the portable electronic device in the related zone, followed by sending a pre-stored webpage data from the wireless network base station to the portable electronic device,
wherein the SSID is configured to be a text code carrying an advertisement data.

2. The additional data delivery method of claim 1, wherein the advertisement data is a store name or a store's service data, wherein the webpage data comprises at least one of a retail service description data, a merchandise data, a merchandise price, and a map.

3. The additional data delivery method of claim 2, wherein the wireless network base station provides Wi-Fi signals and is not connected to the Internet.

4. A localized additional data delivery system for delivering an advertisement data to a portable electronic device located in a related zone, comprising a plurality of wireless network base stations spaced apart and each adapted to deliver at least a beacon signal including a service setting ID (SSID) to a nearby zone such that the at least a beacon signal is received by the portable electronic device entering the zone, wherein the portable electronic device gets connected wirelessly to a related one of the wireless network base stations by means of the at least a beacon signal, wherein the SSID is a text code carrying the advertisement data and is displayed on the portable electronic device, wherein, as soon as the portable electronic device gets connected to the related one of the wireless network base stations, the related one of the wireless network base stations delivers a pre-stored webpage data to the portable electronic device, wherein the webpage data comprises at least one of a retail service description data, a merchandise data, a merchandise price, and a map.

5. The additional data delivery system of claim 4, wherein the wireless network base stations each comprising:
a controlling and processing module for configuring and storing the text code and the webpage data and generating the at least a beacon signal in accordance with the text code; and
an antenna connected to the controlling and processing module and adapted to deliver the at least a beacon signal regularly and provide wireless connection of the portable electronic device.

6. The additional data delivery system of claim 5, wherein the wireless network base stations are each connected to a data storage module, and the data storage module is connected to the controlling and processing module of a corresponding one of the wireless network base stations to further provide data storage space.

7. The additional data delivery system of claim 6, wherein the wireless network base stations each comprise a wired connecting portion connected to the controlling and processing module, and the wired connecting portion includes at least one of a network port and a USB port, wherein the data storage module gets connected to the wireless network base station through the wired connecting portion.

8. The additional data delivery system of claim 7, wherein the wireless network base stations are each a Wi-Fi base station.

9. The additional data delivery system of claim 4, wherein the beacon signals are delivered by each of the wireless network base stations at a frequency which complies with IEEE 802.11 Protocol.

10. A localized additional data delivery system located in a retail zone having a plurality of stores, comprising:
a plurality of wireless network base stations each allocated to a store and adapted to deliver to the retail zone at least a beacon signal including a service setting ID (SSID) accessible to a portable electronic device in the retail zone and displayed on the portable electronic device, wherein the portable electronic device gets connected wirelessly to a related one of the wireless network base stations by means of the beacon signal, wherein the SSID is a text code carrying retail data pertaining to the stores and is displayed on the portable electronic device, wherein, as soon as the portable electronic device gets connected to a related one of the wireless network base stations, the related one of the wireless network base stations delivers a pre-stored webpage data to the portable electronic device, wherein the webpage data includes at least one of a retail service description data, a merchandise data, a merchandise price, and a map.

11. The additional data delivery system of claim 10, wherein the wireless network base stations each comprise:
a controlling and processing module for configuring and storing the text code and the webpage data and generating the at least a beacon signal in accordance with the text code; and
an antenna connected to the controlling and processing module and adapted to deliver the at least a beacon signal regularly and provide wireless connection of the portable electronic device.

12. The additional data delivery system of claim 11, wherein the wireless network base stations are each connected to a data storage module, and the data storage module is connected to the controlling and processing module of a corresponding one of the wireless network base stations to further provide data storage space.

13. The additional data delivery system of claim 12, wherein the wireless network base stations each comprise a wired connecting portion connected to the controlling and processing module, and the wired connecting portion includes at least one of a network port and a USB port, wherein the data storage module gets connected to the wireless network base station through the wired connecting portion.

14. The additional data delivery system of claim 12, wherein the data storage module connected to each said wireless network base station stores membership data accessible to the controlling and processing module, and used for authentication.

15. The additional data delivery system of claim 10, wherein the retail zone harbors a plurality of catering stores.
